(19) United States
(12) Patent Application Publication
(10) Pub. No.: US 2025/0011543 A1
(43) Pub. Date: Jan. 9, 2025

(54) LOW-DIELECTRIC POLYAMIC ACID AND POLYIMIDE FILM

(71) Applicant: PI ADVANCED MATERIALS CO., LTD., Chungcheongbuk-do (KR)

(72) Inventors: Min-Sang CHO, Incheon (KR); Kil-Nam LEE, Bucheon-si (KR); Sung-Yul BACK, Seoul (KR); Su-Kyung CHAE, Incheon (KR)

(73) Assignee: PI ADVANCED MATERIALS CO., LTD., Chungcheongbuk-do (KR)

(21) Appl. No.: 18/713,613

(22) PCT Filed: Nov. 23, 2022
(86) PCT No.: PCT/KR2022/018614

§ 371 Date: May 24, 2024

(30) Foreign Application Priority Data
Nov. 25, 2021 (KR) 10-2021-0164186

(51) Int. Cl. C08G 73/10; B32B 27/08; B32B 27/28; C08J 5/18

(52) U.S. Cl. CPC C08G 73/1082; B32B 27/08; B32B 27/281; C08J 5/18; B32B 2274/00; B32B 2379/08; C08J 2379/08

(57) ABSTRACT

The present invention provides low-dielectric polyamic acid and a polyimide film, the low-dielectric polyamic acid comprising: a dianhydride acid component including two or more selected from the group consisting of biphenyltetracarboxylic dianhydride (BPDA), pyromellitic dianhydride (PMDA), and p-phenylenebis(trimellitate anhydride) (TAHQ); and a diamine component including one or more selected from the group consisting of oxydianiline (ODA), m-tolidine, and paraphenylene diamine (PPD), and the low-dielectric polyamic acid being obtained by copolymerizing the components.

### TECHNICAL FIELD

The present disclosure relates to a polyamic acid having excellent low-dielectric, adhesion, and heat-resistant properties and to a polyimide film.

### BACKGROUND ART

Polyimide (PI) is a polymeric material having the highest level of heat resistance, chemical compatibility, electrical insulation, chemical resistance, and weather resistance of all organic materials on the basis of an imide ring having excellent chemical stability along with a rigid aromatic main chain.

In particular, polyimide is attracting attention as a highly functional polymeric material in electrical, electronic, and optical fields due to having excellent insulation properties, that is, excellent electrical properties such as a low dielectric constant.

Recently, with weight reduction and size reduction in electronic products, flexible thin circuit boards with high integration density are being actively developed.

Such thin circuit boards tend to have a structure, being widely used, in which a circuit including a metal foil is formed on a polyimide film having excellent heat resistance, low-temperature resistance, and insulation properties while being easily bendable.

Flexible metal-clad laminates are mainly used as the thin circuit board, and examples thereof include flexible copper-clad laminates (FCCLs) using a thin copper plate as a metal foil. Furthermore, polyimide is also used in protective films, insulating films, and the like for thin circuit boards.

On the other hand, with various built-in functions in electronic devices, there has recently been a growing need to apply fast calculation and communication speeds to such devices. Additionally, to meet these requirements, thin circuit boards capable of high-speed communication based on high frequencies are being developed.

There is a need for an insulator with a high impedance capable of maintaining electrical insulation properties even at high frequencies to realize high-speed communication at high frequencies. Impedance is inversely proportional to the dielectric constant (Dk) and frequency formed in the insulator, so the dielectric constant must be as low as possible to maintain insulation properties even at high frequencies.

However, in the case of typical polyimide, the level of dielectric properties is not excellent enough to maintain sufficient insulation properties in high-frequency communication.

Additionally, it is known that when an insulator has low-dielectric properties, the stray capacitance and noise, undesirably occurring in thin circuit boards, are likely to be reduced, thereby eliminating most of the causes of communication delays.

Therefore, polyimide having low-dielectric properties is recognized as the most important factor in the performance of thin circuit boards.

In particular, in the case of high-frequency communication, dielectric dissipation inevitably occurs through polyimide. A dielectric dissipation factor (Df) refers to the degree of electrical energy wasted in a thin circuit board and is closely related to signal transmission delays that determine communication speed. Thus, keeping the dielectric dissipation factor of polyimide as low as possible is also recognized as an important factor in the performance of thin circuit boards.

Additionally, the more moisture contained in a polyimide film, the greater the dielectric constant and the higher the dielectric dissipation factor. While being suitable as materials for thin circuit boards due to having excellent inherent properties, polyimide films may be relatively vulnerable to moisture due to the polar imide group, leading to deterioration in insulation properties.

Therefore, there is a need to develop a polyimide film having dielectric properties, especially a low dielectric dissipation factor, while maintaining the unique mechanical, thermal, and high surface adhesion properties of polyimide to a predetermined level.

### DOCUMENT OF RELATED ART

### Patent Document

(Patent Document 1) Korean Patent Application Publication No. 10-2021-0055230

### DISCLOSURE

### Technical Problem

Accordingly, to solve the problems described above, the present disclosure aims to provide a polyamic acid having excellent low-dielectric, high-adhesion, and heat-resistant properties and a polyimide film.

Hence, the present disclosure aims to practically provide specific embodiments thereof.

### Technical Solution

In a first embodiment of the present disclosure for achieving the objectives as described above, a polyamic acid including an acid dianhydride component and a diamine component to be copolymerized, the acid dianhydride component including two or more selected from the group consisting of biphenyl-tetracarboxylic dianhydride (BPDA), pyromellitic dianhydride (PMDA), and p-phenylenebis(trimellitate anhydride) (TAHQ) and

the diamine component including one or more selected from the group consisting of oxydianiline (ODA), m-tolidine, and para-phenylenediamine (PPD),

is provided.

(However, the polyamic acid is required to include m-tolidine as the diamine component.)

In a second embodiment of the present disclosure, a polyimide film obtainable by reacting a polyamic acid solution through an imidization reaction, the polyamic acid solution including an acid dianhydride component including two or more selected from the group consisting of biphenyl-tetracarboxylic dianhydride (BPDA), pyromellitic dianhydride (PMDA), and p-phenylenebis(trimellitate anhydride) (TAHQ) and

a diamine component including one or more selected from the group consisting of oxydianiline (ODA), m-tolidine, and para-phenylenediamine (PPD),

is provided.

(However, the polyimide film is required to include m-tolidine as the diamine component.)

In a third embodiment of the present disclosure, a multilayer film including the polyimide film and a thermoplastic resin layer

is provided.

In a fourth embodiment of the present disclosure, a flexible metal-clad laminate including the polyimide film and an electrically conductive metal foil

is provided.

In a fifth embodiment of the present disclosure, an electronic component including the flexible metal-clad laminate

is provided.

### Advantageous Effects

As described above, the present disclosure provides a polyamic acid composed of specific components in specific composition ratios and a polyimide film having low-dielectric properties, high-adhesion properties, and highly heat-resistant properties, which can thus be usefully applied to various fields in need of such properties, especially electronic components such as flexible metal-clad laminates.

### BEST MODE

Hereinafter, embodiments of the present disclosure will be described in more detail.

All terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Therefore, the embodiments described herein are merely examples and do not exhaustively present the technical spirit of the present disclosure. Accordingly, it should be appreciated that there may be various equivalents and modifications that can replace the embodiments and the configurations at the time at which the present application is filed.

As used herein, the singular forms are intended to include the plural forms as well, unless the context clearly indicates otherwise. It will be further understood that the terms “comprise”, “include”, “have”, and the like when used herein, specify the presence of stated features, integers, steps, components, or combinations thereof but do not preclude the presence or addition of one or more other features, integers, steps, components, or combinations thereof.

When an amount, concentration, other value, or parameter is given herein as a range, preferred range, or enumeration of preferred upper values and preferred lower values, it is to be understood to specifically disclose all ranges formed by pairing of any upper range limit or a preferred value with any lower range limit or a preferred value, regardless of whether the ranges are additionally disclosed.

When a range of numerical values is mentioned herein, this range is intended to include not only the endpoints but also all integers and fractions within the range, unless otherwise stated. The scope of the present disclosure is not intended to be limited to the specific values mentioned when defining the scope.

As used herein, although the term “acid dianhydride” is intended to include precursors or derivatives thereof, these compounds may not technically be acid dianhydride. Nevertheless, these compounds will react with diamine to form polyamic acids, which will be converted to polyimides once more.

As used herein, although the term “diamine” is intended to include precursors or derivatives thereof, these compounds may not technically be diamines. Nevertheless, these compounds will react with dianhydride to form polyamic acids, which will be converted to polyimides once more.

A polyamic acid, according to the present disclosure, may include an acid dianhydride component and a diamine component to be copolymerized, the acid dianhydride component including two or more selected from the group consisting of biphenyl-tetracarboxylic dianhydride (BPDA), pyromellitic dianhydride (PMDA), and p-phenylenebis(trimellitate anhydride) (TAHQ) and the diamine component including one or more selected from the group consisting of oxydianiline (ODA), m-tolidine, and para-phenylenediamine (PPD).

However, the polyamic acid may be required to include m-tolidine as the diamine component.

Preferably, the dianhydride component includes p-phenylenebis(trimellitate

For example, the dianhydride component may be p-phenylenebis(trimellitate anhydride) alone, a combination of p-phenylenebis(trimellitate anhydride) and biphenyl-tetracarboxylic dianhydride, or a combination of p-phenylenebis(trimellitate anhydride) and pyromellitic dianhydride.

Additionally, the diamine component may be m-tolidine alone, a combination of m-tolidine and para-phenylenediamine, or a combination of m-tolidine and oxydianiline.

In one embodiment, the biphenyl-tetracarboxylic dianhydride may have a content of 30 mol % or more and 75 mol % or less, the pyromellitic dianhydride may have a content of 60 mol % or less, and the p-phenylenebis(trimellitate anhydride) may have a content of 30 mol % or more and 70 mol % or less, based on 100 mol % of the total content of the acid dianhydride component.

In one embodiment, based on 100 mol % of the total content of the diamine component, the m-tolidine may have a content of 40 mol % or more and 100 mol % or less, the para-phenylenediamine may have a content of 60 mol % or less, and the oxydianiline may have a content of 60 mol % or less.

In one embodiment, a molar ratio of the m-tolidine to the p-phenylenebis(trimellitate anhydride) (mol % of m-tolidine/p-phenylenebis(trimellitate anhydride)) may be 1.1 or higher and 3.5 or lower.

Preferably, the molar ratio of the m-tolidine to the p-phenylenebis(trimellitate anhydride) (mol % of m-tolidine/p-phenylenebis(trimellitate anhydride)) is 1.5 or higher and 2.9 or lower.

A polyimide film, according to the present disclosure, may be obtainable by reacting a polyamic acid solution through an imidization reaction, the polyamic acid solution including an acid dianhydride component including two or more selected from the group consisting of biphenyl-tetracarboxylic dianhydride (BPDA), pyromellitic dianhydride (PMDA), and p-phenylenebis(trimellitate anhydride) (TAHQ) and a diamine component including one or more selected from the group consisting of oxydianiline (ODA), m-tolidine, and para-phenylenediamine (PPD).

However, the polyimide film may be required to include m-tolidine as the diamine component.

Preferably, the acid dianhydride component includes p-phenylenebis(trimellitate

For example, the dianhydride component may be p-phenylenebis(trimellitate anhydride) alone, a combination of p-phenylenebis(trimellitate anhydride) and biphenyl-tetracarboxylic dianhydride, or a combination of p-phenylenebis(trimellitate anhydride) and pyromellitic dianhydride.

Additionally, the diamine component may be m-tolidine alone, a combination of m-tolidine and para-phenylenediamine, or a combination of m-tolidine and oxydianiline.

In one embodiment, the biphenyl-tetracarboxylic dianhydride may have a content of 30 mol % or more and 75 mol % or less, the pyromellitic dianhydride may have a content of 60 mol % or less, and the p-phenylenebis(trimellitate anhydride) may have a content of 30 mol % or more and 70 mol % or less, based on 100 mol % of the total content of the acid dianhydride component.

When the p-phenylenebis(trimellitate anhydride) content exceeds 70 mol %, the heat resistance of the polyimide film may deteriorate, making film formation challenging.

Additionally, when the biphenyl-tetracarboxylic dianhydride content exceeds 75 mol %, the dielectric dissipation factor of the polyimide film may increase, leading to deterioration in low-dielectric properties.

In one embodiment, based on 100 mol % of the total content of the diamine component, the m-tolidine may have a content of 40 mol % or more and 100 mol % or less, the para-phenylenediamine may have a content of 60 mol % or less, and the oxydianiline may have a content of 60 mol % or less.

In one embodiment, a molar ratio of the m-tolidine to the p-phenylenebis(trimellitate anhydride) (mol % of m-tolidine/p-phenylenebis(trimellitate anhydride)) may be 1.1 or higher and 3.5 or lower.

Preferably, the molar ratio of the m-tolidine to the p-phenylenebis(trimellitate anhydride) is 1.5 or higher and 2.9 or lower.

When the molar ratio of the m-tolidine to the p-phenylenebis(trimellitate anhydride) (mol % of m-tolidine/p-phenylenebis(trimellitate anhydride)) is lower than 1.1 or exceeds 3.5, the dielectric dissipation factor of the polyimide film may increase, leading to deterioration in low-dielectric properties.

In one embodiment, the polyimide film may have a dielectric dissipation factor (Df) of 0.0025 or less and an adhesive strength of 0.8 gf/cm or more.

Preferably, the dielectric dissipation factor of the polyimide film is 0.0026 or less.

Additionally, the polyimide film may have a glass transition temperature of 270° C. or lower. Preferably, the glass transition temperature of the polyimide film is 205° C. or higher.

On the other hand, film formation of the polyimide film may be possible even at a film formation process temperature of 400° C. or higher.

As seen above, the polyimide film, according to the present disclosure, satisfies all the conditions described above and may thus be usable as insulating films for flexible metal-clad laminates. Furthermore, the insulation stability thereof may be obtainable even at high frequencies, and the signal transmission delays may be minimized.

The present disclosure provides: a multilayer film including the polyimide film described above and a thermoplastic resin layer; and a flexible metal-clad laminate including the polyimide film described above and an electrically conductive metal foil.

Examples of the thermoplastic resin layer used may include a thermoplastic polyimide resin layer and the like.

The metal foil used is not particularly limited. However, when using the flexible metal-clad laminate of the present disclosure for electronic or electrical devices, the metal foil may, for example, include copper or an alloy thereof, stainless steel or an alloy thereof, nickel or an alloy thereof (including Alloy 42), and aluminum or an alloy thereof.

In typical flexible metal-clad laminates, copper foils, such as rolled copper foil and electrolytic copper foil, are widely used and are also preferably used in the present disclosure. Additionally, the surface of such metal foils may be coated with an anti-rust layer, a heat-resistant layer, or an adhesive layer.

The thickness of the metal foil is not particularly limited in the present disclosure and may be any thickness capable of demonstrating sufficient functions depending on the intended use.

The flexible metal-clad laminate, according to the present disclosure, may have a structure in which the metal foil is laminated onto one surface of the polyimide film or a structure in which an adhesive layer containing thermoplastic polyimide is added to one surface of the polyimide film, and the metal foil is laminated while being attached to the adhesive layer.

Additionally, the present disclosure provides an electronic component including the flexible metal-clad laminate as an electrical signal transmission circuit. The electrical signal transmission circuit may be an electronic component configured to transmit signals at a high frequency of at least 2 GHz, specifically at a high frequency of at least 5 GHZ, and more specifically at a high frequency of at least 10 GHz.

Examples of the electronic component may include a communication circuit for a mobile phone, a communication circuit for a computer, or a communication circuit for aerospace but are not limited thereto.

The preparation of the polyamic acid in the present disclosure may, for example, involve:
(1) a polymerization method by adding the entire amount of the diamine component in a solvent and then adding the acid dianhydride component so that the amount thereof is substantially equimolar to that of the diamine component;
(2) a polymerization method by adding the entire amount of the acid dianhydride component in a solvent and then adding the diamine component so that the amount thereof is substantially equimolar to that of the acid dianhydride component;
(3) a polymerization method by adding some of the diamine component to a solvent, mixing some of the acid dianhydride component in a ratio of about 95 to 105 mol % to the reaction component, adding the remaining diamine component, and then subsequently adding the remaining acid dianhydride component so that the diamine component and the acid dianhydride component are substantially equimolar;
(4) a polymerization method by adding some of the acid dianhydride component to a solvent, mixing some of the diamine compound in a ratio of about 95 to 105 mol % to the reaction component, adding the remaining acid dianhydride component, and then subsequently adding the remaining diamine component so that the diamine component and the acid dianhydride component are substantially equimolar;
(5) a polymerization method by reacting some of the diamine component and some of the acid dianhydride component in a first solvent so that either one is in excess to form a first composition, reacting some of the diamine component and some of the acid dianhydride component in a second solvent so that either one is in excess to form a second composition, and mixing the first and second compositions to complete polymerization, wherein when the diamine component is in excess when forming the first composition, the acid dianhydride component in the second composition is contained in an excessive amount, and when the acid dianhydride component is in excess in the first composition, the diamine component in the second composition is contained in an excessive amount to mix the first and second compositions so that the entire diamine component and acid dianhydride component used in the reaction are substantially equimolar; and the like.

However, the polymerization method is not limited to the above examples, and any known method may be used to prepare the polyamic acid.

In one specific example, a method of forming the polyimide film, according to the present disclosure, may include the following steps: preparing a polyamic acid by polymerizing an acid dianhydride component and a diamine component, the acid dianhydride component including two or more selected from the group consisting of biphenyl-tetracarboxylic dianhydride (BPDA), pyromellitic dianhydride (PMDA), and p-phenylenebis(trimellitate anhydride) (TAHQ) and the diamine component including one or more selected from the group consisting of m-tolidine and para-phenylenediamine (PPD); and

forming a film by positioning a precursor composition containing the polyamic acid on a support and imidizing the resulting product.

In the present disclosure, such a polymerization method of the polyamic acid described above may be defined as a random polymerization method. Additionally, the polyimide film of the present disclosure, formed from the polyamic acid prepared through such a process described above, is preferably applicable for maximizing the effect of the present disclosure in reducing the dielectric dissipation factor (Df), moisture absorption rate, and gas permeability.

However, the polymerization method makes the length of the repeating unit in the polymer chain described above relatively short, so there may be limitations in demonstrating each of the excellent properties of the polyimide chain derived from the acid dianhydride component. Therefore, block polymerization may be performed as the polymerization method of the polyamic acid, which is further preferably usable in the present disclosure.

On the other hand, the solvent for synthesizing the polyamic acid is not particularly limited, and any solvent capable of dissolving the polyamic acid may be usable. However, an amide-based solvent is preferably used.

Specifically, the solvent may be a polar organic solvent, which may be, in particular, a polar aprotic solvent. Examples thereof may include one or more selected from the group consisting of N,N-dimethylformamide (DMF), N,N-dimethylacetamide, N-methyl-pyrrolidone (NMP), gamma-butyrolactone (GBL), and diglyme, but the solvent is not limited thereto. If necessary, the solvent may be used alone, or two or more types may be used in combination.

In one example, N,N-dimethylformamide and N,N-dimethylacetamide are further preferably used as the solvent.

Additionally, in the polyamic acid preparation process, fillers may be added to improve various properties of the film, such as sliding properties, thermal conductivity, corona resistance, loop hardness, and the like. The filler added is not particularly limited, but preferred examples thereof include silica, titanium oxide, alumina, silicon nitride, boron nitride, calcium hydrogen phosphate, calcium phosphate, mica, and the like.

The particle diameter of the filler is not particularly limited but may be determined depending on the properties of a film to be modified and the type of fillers to be added. Typically, the average particle diameter is in a range of 0.05 to 100 μm, which is preferably in the range of 0.1 to 75 μm, more preferably in the range of 0.1 to 50 μm, and even more preferably in the range of 0.1 to 25 μm.

When the particle diameter is smaller than the above range, the modification effect may be challenging to exhibit, and when the particle diameter is larger than the above range, the surface properties may be seriously damaged, or the mechanical properties may significantly deteriorate.

Additionally, the amount of the filler added is not particularly limited but may be determined by the properties of a film to be modified, the particle diameter of the filler, or the like. Typically, the amount of the filler added is in a range of 0.01 to 100 parts by weight with respect to 100 parts by weight of the polyimide, which is preferably in the range of 0.01 to 90 parts by weight and more preferably in the range of 0.02 to 80 parts by weight.

When the amount of the filler added is smaller than the above range, the modification effect by the filler may be challenging to exhibit, and when the amount of the filler added is greater than the above range, the mechanical properties of the film may be seriously damaged. The method of adding the filler is not particularly limited, and any known methods may be used.

In the formation method of the present disclosure, the polyimide film may be formed by a thermal imidization method and a chemical imidization method.

Additionally, the polyimide film may be formed by a complex imidization method in combination of the thermal imidization and chemical imidization methods.

The thermal imidization method is a method of inducing an imidization reaction using a heat source such as an infrared dryer or hot air, without involving a chemical catalyst.

The thermal imidization method may enable the amic acid group present in a gel film to be imidized by subjecting the gel film to heat treatment at a variable temperature in a range of 100° C. to 600° C. Specifically, the heat treatment may be performed at a temperature in a range of 200° C. to 500° C., which is more specifically in the range of 300° C. to 500° C., to imidize the amic acid group present in the gel film.

However, even in the gel film formation process, some of the amic acid (about 0.1 to 10 mol %) may be imidized. To this end, the polyamic acid composition may be dried at a variable temperature in a range of 50° C. to 200° C., which may also fall within the scope of the thermal imidization method.

In the case of the chemical imidization method, a dehydrating agent and an imidizing agent may be used according to methods known in the art to form the polyimide film.

As one example of the complex imidization method, a dehydrating agent and an imidizing agent may be introduced into a polyamic acid solution, heated at a temperature in a range of 80° C. to 200° C., which is preferably in the range of 100° C. to 180° C., partially cured and dried, and then heated at a temperature in a range of 200° C. to 400° C. for 5 to 400 seconds, thereby forming the polyimide film.

### MODE FOR INVENTION

Hereinafter, the action and effect of the present disclosure will be described in detail through specific examples of the present disclosure. However, such examples are provided only for illustrative purposes, and the scope of the present disclosure is not limited to the following examples.

### Preparation Example: Polyimide Film Formation

A polyimide film of the present disclosure may be formed by typical methods known in the art, as follows. First, the acid dianhydride and diamine components mentioned above are allowed to react in an organic solvent to obtain a polyamic acid solution.

In this case, the solvent used, typically an amide-based solvent, is a polar aprotic solvent, which may be N,N′-dimethylformamide, N,N′-dimethylacetamide, N-methyl-pyrrolidone, or a combination thereof.

The acid dianhydride and diamine components are enabled to be introduced in a solution, powder, or lump form. Preferably, the reaction occurs by introducing the components in a powder form at the beginning of the reaction and then in a solution form to control the polymerization viscosity.

The polyamic acid solution obtained in such a manner may be mixed with an imidization catalyst and a dehydrating agent so as to be applied onto a support.

Examples of the catalyst used may include tertiary amines (for example, isoquinoline, β-picoline, pyridine, and the like), and examples of the dehydrating agent may include anhydrous acids, but the catalyst and the dehydrating agent are not limited thereto. Additionally, the support used above may be a glass plate, aluminum foil, circular stainless belt, stainless drum, or the like, but is not limited thereto.

The film applied onto the support is turned into a gel form on the support by drying air and heat treatment.

The gel film formed in such a manner is separated from the support, subjected to heat treatment, dried, and then imidized.

The film obtained through the heat treatment above may be subjected to heat treatment under a predetermined tension to remove residual stress generated in the film during the film formation process.

Specifically, 500 ml of dimethylformamide (DMF) is introduced while injecting nitrogen into a reactor equipped with a stirrer and nitrogen injection/discharge pipes, and the reactor temperature is set to 30° C. Next, biphenyl-tetracarboxylic dianhydride (BPDA), pyromellitic dianhydride (PMDA), p-phenylenebis(trimellitate anhydride) (TAHQ), m-tolidine (MTD), para-phenylenediamine (PPD), and oxydianiline (ODA) are introduced in a controlled composition ratio in a predetermined order and completely dissolved. Then, the resulting product was heated by raising the reactor temperature to 40° C. under a nitrogen atmosphere with continuous stirring for 120 minutes, thereby preparing a polyamic acid having a primary reaction viscosity of 1,500 cP.

The polyamic acid prepared in such a manner was stirred to have a final viscosity in a range of 100,000 to 120,000 cP.

After adding the catalyst and the dehydrating agent to the prepared final polyamic acid by adjusting the contents thereof, an applicator was used to form a polyimide film.

### Examples and Comparative Examples

As shown in Table 1 below, the contents of the acid dianhydride and diamine components in Examples 1 to 6 and Comparative Examples 1 to 3 were adjusted to form each polyimide film according to the preparation example.

In the polyimide films of Examples 1 to 6, a molar ratio of m-tolidine to p-phenylenebis(trimellitate anhydride) (mol % of m-tolidine/p-phenylenebis(trimellitate anhydride)) was adjusted to be 1.1 or higher and 3.5 or lower.

TABLE 1

| | Acid dianhydride (mol %) | | | Diamine (mol %) | | |
|---|---|---|---|---|---|---|
| | TAHQ | BPDA | PMDA | MTD | PPD | ODA |
| Example 1 | 50 | 50 | — | 100 | — | — |
| Example 2 | 35 | 65 | — | 100 | — | — |
| Example 3 | 65 | 35 | — | 100 | — | — |
| Example 4 | 50 | — | 50 | 100 | — | — |
| Example 5 | 25 | 75 | — | 50 | 50 | — |
| Example 6 | 25 | 75 | — | 50 | — | 50 |
| Comparative | 50 | 50 | — | — | — | 100 |
| Example 1 | | | | | | |
| Comparative | 25 | 75 | — | 100 | — | — |
| Example 2 | | | | | | |
| Comparative | 75 | 25 | — | 100 | — | — |
| Example 3 | | | | | | |

The dielectric dissipation factor (Df), adhesive strength, and glass transition temperature (Tg) of the polyimide films formed in such a manner were measured, and film formation properties were observed at a process temperature of 400° C. The results thereof are shown in Table 2 below.

TABLE 2

| | Dielectric | Adhesive | Glass transition | Film |
|---|---|---|---|---|
| | dissipation | strength | temperature | formation |
| | factor | (kfg/cm) | (° C.) | properties |
| Example 1 | 0.0016 | >0.8 | 220 | ◯ |
| Example 2 | 0.0021 | >0.8 | 255 | ◯ |
| Example 3 | 0.0023 | >0.8 | 210 | ◯ |
| Example 4 | 0.0025 | >0.8 | 265 | ◯ |
| Example 5 | 0.0022 | >0.8 | 255 | ◯ |
| Example 6 | 0.0024 | >0.8 | 230 | ◯ |
| Comparative | — | — | — | X |
| Example 1 | | | | |
| Comparative | 0.0031 | >0.8 | 273 | ◯ |
| Example 2 | | | | |
| Comparative | — | — | — | X |
| Example 3 | | | | |

In Table 2, “O” for film formation properties indicates that a film was formed at a process temperature of 400° C., and “X” indicates that no film was formed at a process temperature of 400° C.

The methods of measuring the dielectric dissipation factor (Df), adhesive strength, and glass transition temperature of the polyimide films formed in such a manner are as follows.

### (1) Measurement of Dielectric Dissipation Factor

Measurement of the dielectric dissipation factor (Df) was performed on each film left in an environment of 23° C./50% RH for 24 hours by a cavity resonance method (SPDR) using ENA (vector network analyzer) purchased from Keysight.

### (2) Measurement of Adhesive Strength

Regarding the adhesive strength, bonding sheets (1 mil, Epoxy type) were placed on both surfaces of each polyimide film, and ½ oz copper foil was positioned on both surfaces while placing a protective PI film and raising the temperature to 160° C. Then, heat compression was performed through a pressure of 5 MPa for 30 minutes. The resulting film was cut to a size with a 10-mm width and then subjected to a 180° peel test.

### (3) Measurement of Glass Transition Temperature

For the glass transition temperature (Tg), the loss modulus and storage modulus of each film were calculated by DMA, and the inflection point in the tangent graph thereof was measured as the glass transition temperature.

As shown in Table 2, it was confirmed that the polyimide films, formed according to the examples of the present disclosure, not only exhibited a low dielectric dissipation factor, which was 0.0025 or less, but also showed an adhesive strength of 0.8 gf/cm or more.

Additionally, the glass transition temperature corresponded to 270° C. or lower, and no problems occurred in film formation even at a process temperature of 400° C.

In contrast, in Comparative Example 1, in which the composition ratio and components of the acid dianhydride were the same as those in Example 1 while using only oxydianiline as the diamine component, the heat resistance significantly deteriorated, so no film was formed.

Additionally, in Comparative Example 3, including more than 70 mol % of p-phenylenebis(trimellitate anhydride) by increasing the p-phenylenebis(trimellitate anhydride) content compared to that in Examples 1 to 3, the heat resistance significantly deteriorated, so no film was formed.

On the other hand, in Comparative Example 2, in which the molar ratio of m-tolidine to p-phenylenebis(trimellitate anhydride) (mol % of m-tolidine/p-phenylenebis(trimellitate anhydride)) exceeded 3.5 by adjusting the molar ratio of m-tolidine to p-phenylenebis(trimellitate anhydride) compared to that in Examples 1 to 3, no problems occurred in film formation. However, the dielectric dissipation factor exceeded 0.0025, and the glass transition temperature exceeded 270° C.

Therefore, it is seen that the low-dielectric properties and heat resistance of the polyimide film herein are achieved by the components and composition ratios specified herein.

On the other hand, in the case of Comparative Examples 1 to 3, in which the components and composition ratios applied differed from those in the case of the examples, there was a problem in film formation properties due to poor heat resistance or the high dielectric dissipation factor compared to that in the case of the examples. Therefore, the comparative examples may have difficulty being used in electronic components where signal transmission occurs at high frequencies in gigahertz.

Although the present disclosure has been described above with reference to examples of the present disclosure, those skilled in the art will be able to make various applications and modifications based on the above contents within the scope of the present disclosure.

### INDUSTRIAL APPLICABILITY

The present disclosure provides a polyamic acid composed of specific components in specific composition ratios and a polyimide film having low-dielectric properties, high-adhesion properties, and highly heat-resistant properties, which may thus be usefully applied to various fields in need of such properties, especially electronic components such as flexible metal-clad laminates.

1. A polyamic acid comprising an acid dianhydride component and a diamine component to be copolymerized, the acid dianhydride component comprising two or more selected from the group consisting of biphenyl-tetracarboxylic dianhydride (BPDA), pyromellitic dianhydride (PMDA), and p-phenylenebis(trimellitate anhydride) (TAHQ) and the diamine component comprising one or more selected from the group consisting of oxydianiline (ODA), m-tolidine, and para-phenylenediamine (PPD) (wherein the polyamic acid is required to comprise m-tolidine as the diamine component).

2. The polyamic acid of claim 1, wherein the biphenyl-tetracarboxylic dianhydride has a content of 30 mol % or more and 75 mol % or less, the pyromellitic dianhydride has a content of 60 mol % or less, and the p-phenylenebis(trimellitate anhydride) has a content of 30 mol % or more and 70 mol % or less, based on 100 mol % of the total content of the acid dianhydride component.

3. The polyamic acid of claim 1, wherein the m-tolidine has a content of 40 mol % or more and 100 mol % or less,
the para-phenylenediamine has a content of 60 mol % or less, and
the oxydianiline has a content of 60 mol % or less, based on 100 mol % of the total content of the diamine component.

4. The polyamic acid of claim 1, wherein a molar ratio of m-tolidine to p-phenylenebis(trimellitate anhydride) (mol % of m-tolidine/p-phenylenebis(trimellitate anhydride)) is 1.1 or higher and 3.5 or lower.

5. A polyimide film obtainable by reacting a polyamic acid solution through an imidization reaction, the polyamic acid solution comprising:
an acid dianhydride component comprising two or more selected from the group consisting of biphenyl-tetracarboxylic dianhydride (BPDA), pyromellitic dianhydride (PMDA), and p-phenylenebis(trimellitate anhydride) (TAHQ); and
a diamine component comprising one or more selected from the group consisting of oxydianiline (ODA), m-tolidine, and para-phenylenediamine (PPD) (wherein the polyimide film is required to comprise m-tolidine as the diamine component).

6. The polyimide film of claim 5, wherein the biphenyl-tetracarboxylic dianhydride has a content of 30 mol % or more and 75 mol % or less, the pyromellitic dianhydride has a content of 60 mol % or less, and the p-phenylenebis(trimellitate anhydride) has a content of 30 mol % or more and 70 mol % or less, based on 100 mol % of the total content of the acid dianhydride component.

7. The polyimide film of claim 5, wherein the m-tolidine has a content of 40 mol % or more and 100 mol % or less,
the para-phenylenediamine has a content of 60 mol % or less, and
the oxydianiline has a content of 60 mol % or less, based on 100 mol % of the total content of the diamine component.

8. The polyimide film of claim 5, wherein a dielectric dissipation factor (Df) is 0.0025 or less, and
an adhesive strength is 0.8 gf/cm or more.

9. The polyimide film of claim 5, wherein a molar ratio of m-tolidine to p-phenylenebis(trimellitate anhydride) (mol % of m-tolidine/p-phenylenebis(trimellitate anhydride)) is 1.1 or higher and 3.5 or lower.

10. A multilayer film comprising:
the polyimide film of claim 5; and
a thermoplastic resin layer.

11. (canceled)

12. (canceled)
